(19) United States
(12) Patent Application Publication
(10) Pub. No.: US 2009/0126697 A1
(43) Pub. Date: May 21, 2009

(54) FUEL-FEEDING SYSTEM AND THREE-WAY VALVE FOR USE IN THE SYSTEM

(75) Inventors: Yasunori TAKAKU, Nagoya-shi (JP); Kimiya NAKATA, Nagoya-shi (JP); Yoji TSUZUKI, Anjo-shi (JP); Hideki ITO, Kuwana-shi (JP)

Correspondence Address: DENNISON, SCHULTZ & MACDONALD, 1727 KING STREET, SUITE 105, ALEXANDRIA, VA, 22314, US

(73) Assignee: AISAN KOGYO KABUSHIKI KAISHA, Obu-shi (JP)

(21) Appl. No.: 12/237,652

(22) Filed: Sep. 25, 2008

(30) Foreign Application Priority Data
Nov. 21, 2007 (JP) 2007-301628

(51) Int. Cl. F02M 37/04

(52) U.S. Cl. 123/506

(57) ABSTRACT

A fuel-feeding system may preferably include a fuel tank containing liquid fuel; a fuel pump capable of pumping the liquid fuel contained in the fuel tank; a fuel injection valve capable of injecting the liquid fuel pumped by the fuel pump; and a three-way valve having a first port, a second port and a third port. The three-way valve is constructed so as to be switched between a first condition in which the first, second and third ports communicate with each other and a second condition in which only the first and third ports communicate with each other. The fuel injection valve is connected to the third external conduit at a position between the third port and the second relief valve, so that a pressure of the liquid fuel fed to the fuel injection valve can be switched between the first setting pressure and the second setting pressure when the three-way valve is switched between the first condition and the second condition.

This application claims priority to Japanese patent application serial number 2007-301628, the contents of which are incorporated herein by reference.

### BACKGROUND OF THE INVENTION

The present invention relates to a fuel-feeding system for injecting liquid fuel via a fuel injection valve. Particularly, the present invention relates to a fuel-feeding system for injecting liquid fuel via a fuel injection valve in which a fuel pressure (a pressure of the liquid fuel fed to the fuel injection valve) can be changed, and a three-way valve for use in the fuel-feeding system.

Generally, a vehicle driven by an internal-combustion engine is provided with a fuel-feeding system that is capable of injecting liquid fuel into the internal-combustion engine. Often, the engine of the vehicle is stopped after an engine temperature is raised, and is then restarted. For example, often, the engine is stopped in a rest area of an expressway, and is restated within a short period of time afterward. In such a case, bubbles can be produced in a fuel piping of the fuel-feeding system because the fuel in the fuel piping is still hot. Therefore, the fuel cannot be sufficiently fed to the engine when the engine is restarted. As a result, the engine cannot be smoothly restarted.

Conventionally, in order to increase start-up performance of the engine even if the engine temperature is raised, the fuel-feeding system is constructed such that a fuel pressure (a pressure of the fuel fed to a fuel injection valve) can be temporarily increased when the engine is started. According to this structure, when the engine is started, the bubbles produced in the fuel piping can be compressed, so that the fuel can be sufficiently fed to the fuel injection valve (the engine). As a result, the engine can be smoothly restarted.

For example, in order to increase the fuel pressure when the engine is started, the fuel-feeding system is constructed such that the liquid fuel (low-pressure fuel) fed to the fuel injection valve can be temporarily changed to highly pressurized fuel (high-pressure fuel) when the engine is started. Generally, in order to change the low-pressure fuel to the high-pressure fuel, the fuel-feeding system includes a three-way valve that is disposed in the fuel piping.

An example of the three-way valve is shown in FIG. 7. The conventional three-way valve 100 may generally include a valve body portion 120 and a magnetic actuator portion 110 coupled to the valve body portion 120 via a connecting plate 113. The valve body portion 120 includes a first port 121, a second port 122 and a third port 123. The valve body portion 120 further includes a valve unit that is disposed therein. The valve unit is composed of a valve element 124 and first and second valve seats 125A and 125B. Conversely, the magnetic actuator portion 110 includes a magnetic coil 111 that is electrically connected to a power source (not shown) via a connector 112.

According to the three-way valve 100, when the magnetic coil 111 is actuated, a valve stem 124a of valve element 124 is projected toward the first valve seat 125A, so that the valve element 124 can contact the first valve seat 125A. At this time, the valve element 124 is moved away from the second valve seat 125B. As a result, the second port 122 is closed, so that first and third ports 121 and 123 can communicate with each other. (Thus, the low pressure fuel pumped through the third port 123 can be fed into the fuel injection valve via the first port 121.) Conversely, when the magnetic coil 111 is deactuated, the valve stem 124a is retracted into the magnetic coil 111, so that the valve element 124 can contact the second valve seat 125B. At this time, the valve element 124 is moved away from the first valve seat 125A. As a result, the third port 123 is closed, so that first and second ports 121 and 122 can communicate with each other. (Thus, the high pressure fuel pumped through the second port 122 can be fed into the fuel injection valve via the first port 121.)

Another example of the three-way valve is disclosed in Japanese Laid-Open Utility Model Publication No. 63-182378. The three-way valve taught by this publication may generally include a valve body portion and a magnetic actuator portion coupled to the valve body portion. The valve body portion includes an inlet port, a first outlet port and a second outlet port. The valve body portion further includes a valve unit that is disposed therein. The valve unit is composed of a valve element and first and second valve seats. Further, the magnetic actuator portion includes a magnetic coil.

According to the three-way valve thus constructed, when the magnetic coil is actuated, the valve element can contact the first valve seat. At this time, the valve element is moved away from the second valve seat. As a result, the second outlet port is closed, so that the inlet port and the first outlet port can communicate with each other. Conversely, when the magnetic coil is deactuated, the valve element can contact the second valve seat. At this time, the valve element is moved away from the first valve seat. As a result, the first outlet port is closed, so that the inlet port and the second outlet port can communicate with each other.

Further, an another fuel-feeding system is disclosed in Japanese Laid-Open Patent Publication No. 2002-339823. In the fuel-feeding system, in order to increase start-up performance of the engine under a condition that the engine temperature is raised, the fuel-feeding system is constructed such that the babble containing fuel (hot fuel) remaining in the fuel piping can be instantly replaced with the fuel (cool fuel) in a fuel tank when the engine is started. In particular, the fuel-feeding system includes first and second fuel pumps and a relief valve that are respectively disposed in the fuel piping. The first and second fuel pumps are arranged so as to be switched between a series arrangement and a parallel arrangement in the fuel piping. Also, the relief valve can be switched between a high pressure position and a low pressure position.

In this structure, when the engine is started (i.e., an ignition is turned on), the first and second fuel pumps are switched to the series arrangement in the fuel piping, and at the same time, the relief valve is switched to the low pressure position. Thereafter, the first and second fuel pumps are operated while the fuel injection valve is not actuated. As a result, the fuel (hot fuel) in the fuel piping can be purged and replaced with the fuel (cool fuel) in the fuel tank. Subsequently, the first and second fuel pumps are switched to the parallel arrangement in the fuel piping, and at the same time, the relief valve is switched to the high pressure position. Thereafter, the first and second fuel pumps are operated, and at the same time, the fuel injection valve is actuated. Thus, the fuel (cool fuel) in the fuel piping can be injected via the fuel injection valve. The fuel (cool fuel) thus injected does not contain the bubbles. Therefore, the fuel can be sufficiently fed to the engine. As a result, the engine can be smoothly restarted even if the engine is in a heated condition.

However, the fuel-feeding system taught by Japanese Laid-Open Patent Publication No. 2002-339823 includes the first and second (two) fuel pumps that can be switched between the series arrangement and the parallel arrangement in the fuel piping. Therefore, a plurality of valves are required in order to switch the fuel pumps between the series arrangement and the parallel arrangement. As a result, the number of components of the fuel-feeding system is increased. This may lead to a complicated structure of the fuel-feeding system. Also, the fuel-feeding system includes the relief valve that can be switched between the high pressure position and the low pressure position. However, such a relief valve may have a complicated structure. This may lead to an increased manufacturing cost of the fuel-feeding system. In addition, such a relief valve cannot be easily switched between the high pressure position and the low pressure position.

Thus, there is a need in the art for an improved fuel-feeding system of an internal combustion engine.

### BRIEF SUMMARY OF THE INVENTION

For example, in one embodiment of the present invention, a fuel-feeding system may include a fuel tank containing liquid fuel; a fuel pump capable of pumping the liquid fuel contained in the fuel tank; a fuel injection valve capable of injecting the liquid fuel pumped by the fuel pump; and a three-way valve having a first port, a second port and a third port. The three-way valve is constructed so as to be switched between a first condition in which the first, second and third ports communicate with each other and a second condition in which only the first and third ports communicate with each other. The first port communicates with the fuel pump via a first external conduit. The second port communicates with the fuel tank via a second external conduit having a first relief valve that is set to a first setting pressure. The third port communicates with the fuel tank via a third external conduit having a second relief valve that is set to a second setting pressure higher than the first setting pressure. The fuel injection valve is connected to the third external conduit at a position between the third port and the second relief valve, so that a pressure of the liquid fuel fed to the fuel injection valve can be switched between the first setting pressure and the second setting pressure when the three-way valve is switched between the first condition and the second condition.

According to the fuel-feeding system thus constructed, the liquid fuel pumped by the fuel pump can be adjusted to the first setting pressure or the second setting pressure by simply switching the three-way valve between the first condition and the second condition. Also, the pressure of the pumped liquid fuel can be accurately controlled to the first setting pressure or the second setting pressure by means of the first and second relief valves.

Further, the fuel-feeding system can be structurally simplified. In addition, the pressure of the pumped liquid fuel can be switched between the first setting pressure and the second setting pressure during operation of the fuel-feeding system.

In another embodiment of the present invention, a three-way valve may include a magnetic coil; a valve unit that is actuated by the magnetic coil; a first port, a second port and a third port; a fluid roundabout cavity in which the valve unit is disposed; and a main internal passage that extends along a valve axis of the valve unit. The three-way valve is constructed so as to be switched between a first condition in which the first, second and third ports communicate with each other and a second condition in which only the first and third ports communicate with each other. In the first condition, fluid introduced via the first port can flow through the second and third ports, and in the second condition, the fluid introduced via the first port can flow through the third port without flowing through the second port. The third port is positioned closer to the magnetic coil than the first port. The first and third ports, the main internal passage and the fluid roundabout cavity are arranged and constructed such that the fluid introduced into the main internal passage via the first port can be introduced into the fluid roundabout cavity and then be directed into the third port.

The three-way valve thus constructed result in a simplified structure. Also, the three-way valve may have increased cooling performance of the magnetic coil.

Other objects, features, and advantages, of the present invention will be readily understood after reading the following detailed description together with the accompanying drawings and the claims.

### BRIEF DESCRIPTION OF THE DRAWINGS

FIG. 1 is a cross-sectional view of a three-way valve used in a fuel-feeding system according to a representative embodiment of the present invention, which corresponds to a cross-sectional view of the three-way valve taken along a valve axis;

FIG. 2 is a sectional view taken along line II-II of FIG. 1;

FIG. 3 is a partially enlarged view of FIG. 1, illustrating a condition in which a second port is closed;

FIG. 4 is a partially enlarged view of FIG. 1, illustrating a condition in which the second port is opened;

FIG. 5 is a schematic diagram of the fuel-feeding system;

FIG. 6 is a cross-sectional view of the three-way valve, illustrating a flow of a fuel when the second port is opened;

FIG. 7 is a cross-sectional view of a conventional three-way valve.

### DETAILED DESCRIPTION OF THE INVENTION

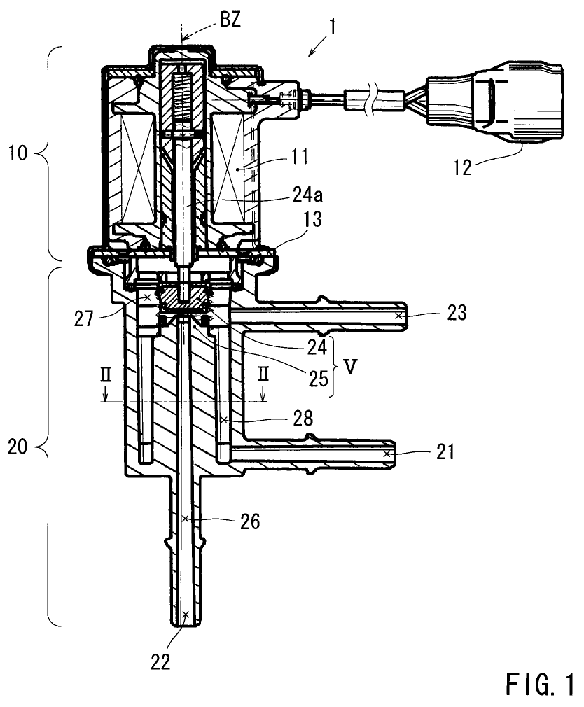

In the following, a fuel-feeding system according to a detailed representative embodiment of the present invention will be described with reference to FIG. 1 to FIG. 6.

Further, in this embodiment, a fuel-feeding system for an internal-combustion engine is exemplified as the fuel-feeding system.

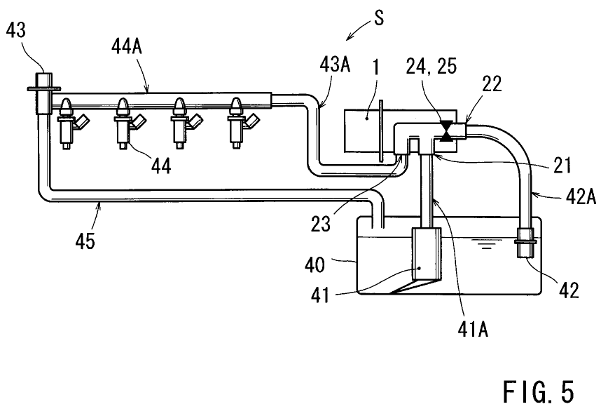

As shown in FIG. 5, the fuel-feeding system S may preferably include a fuel tank 40 that contains liquid fuel (fluid) therein, fuel injection valves 44, a fuel pump 41, a three-way valve 1, a first relief valve 42 and a second relief valve 43. The fuel injection valves 44 are respectively arranged and constructed to inject the liquid fuel to the internal-combustion engine (not shown). The fuel pump 41 is arranged and constructed to pump the liquid fuel in the fuel tank 40 toward the fuel injection valves 44. Also, the three-way valve 1 has a first port 21, a second port 22 and a third port 23.

As shown in FIG. 5, the first port 21 of the three-way valve 1 communicates with the fuel pump 41 disposed in the fuel tank 41 via a first external conduit 41A. The second port 22 of the three-way valve 1 communicates with the first relief valve 42 disposed in the fuel tank 40 via a second external conduit 42A. Further, the second external conduit 42A may preferably be bent at a small curvature (at a large radius of curvature) in order to reduce the loss of pressure produced therein. The third port 23 of the three-way valve 1 communicates with the second relief valve 43 via a third external conduit 43A. The third external conduit 43A may preferably include a delivery tube 44A. The second relief valve 43 communicates with the fuel tank 40 via a return pipe 45. Further, the fuel injection valves 44 are connected to the delivery tube 44A, so as to inject the liquid fuel fed into the delivery tube 44A to the internal-combustion engine.

The first relief valve 42 may preferably be designed for low pressure service. The first relief valve 42 can be set to a first or low setting pressure with a high degree of accuracy. The first setting pressure may preferably be about 284 kPa. Conversely, the second relief valve 43 may preferably be designed for high pressure service. The second relief valve 43 can be set to a second or high setting pressure with a high degree of accuracy. The second setting pressure may preferably be about 400 kPa.

Therefore, when the liquid fuel is pumped by the fuel pump 41 while the second port 22 of the three-way valve 1 is opened (the first and third ports 21 and 23 of the three-way valve 1 are constantly opened), the first relief valve 42 may suitably function, so that the liquid fuel can be fed into the third external conduit 43A (the delivery tube 44A) at a low pressure corresponding to the first setting pressure. If a pressure of the pumped liquid fuel exceeds the first setting pressure, a portion of the liquid fuel can be discharged into the fuel tank 40 via the first relief valve 42, so that the pressure of the liquid fuel in the third external conduit 43A can be maintained in the first setting pressure. Conversely, when the liquid fuel is pumped by the fuel pump 41 while the second port 22 of the three-way valve 1 is closed, the second relief valve 43 may suitably function, so that the liquid fuel can be fed into the third external conduit 43A (the delivery tube 44A) at a high pressure corresponding to the second setting pressure. If the pressure of the pumped liquid fuel exceeds the second setting pressure, a portion of the liquid fuel can be discharged into the fuel tank 40 through the return pipe 45 via the second relief valve 43, so that the pressure of the liquid fuel in the third external conduit 43A can be maintained in the second setting pressure.

The three-way valve 1 is connected to a control unit (not shown), so as to be switched between a first or low pressure condition and a second or high pressure condition. In the low pressure condition, the second port 22 is opened so that the first, second and third ports 21, 22 and 23 can communicate with each other. Conversely, in the high pressure condition, the second port 22 is closed so that only the first and third ports 21 and 23 can communicate with each other. As described above, when the three-way valve 1 is switched to the low pressure condition, the first relief valve 42 may suitably function, so that the liquid fuel pumped into the third external conduit 43A by the fuel pump 41 can be maintained in the first setting pressure. Conversely, when the three-way valve 1 is switched to the high pressure condition, the second relief valve 43 may suitably function, so that the liquid fuel pumped into the third external conduit 43A can be maintained in the second setting pressure.

Further, the three-way valve 1 can be switched between the low pressure condition and the high pressure condition during operation of the fuel-feeding system S.

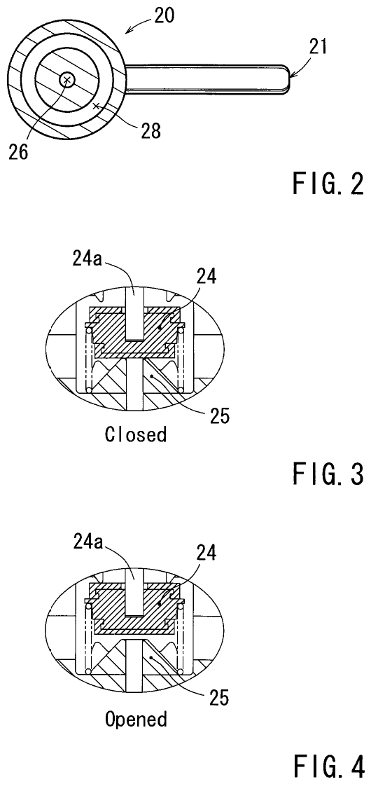

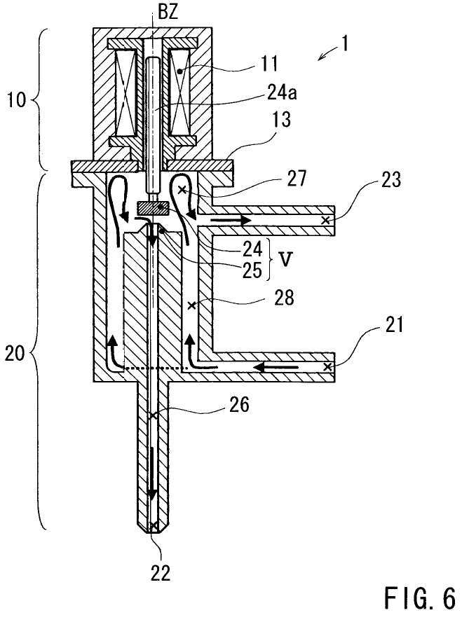

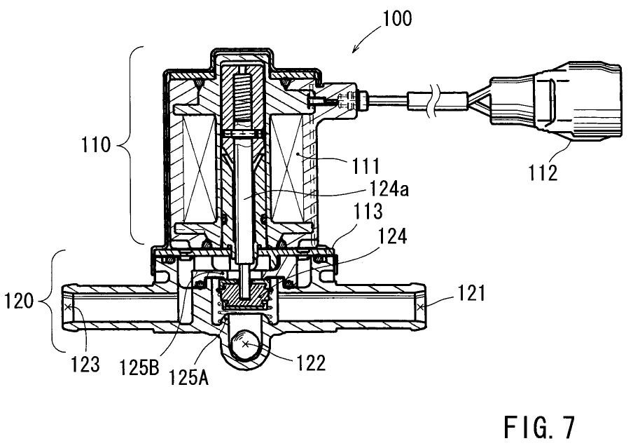

As shown in FIGS. 1 and 6, the three-way valve 1 may preferably be constructed as a solenoid valve. The three-way valve 1 includes a valve body portion 20 having the first port 21, the second port 22 and the third port 23, and a magnetic actuator portion 10 coupled to the valve body portion 20 via a connecting plate 13. As shown in FIGS. 1 and 2, the first and second ports 21 and 22 are communicated with each other via a first internal passage 26, a fluid (fuel) flow inversion cavity (a fuel circuitous or roundabout cavity) 27 and a second or main internal passage 28 that are respectively formed in the valve body portion 20. The valve body portion 20 further includes a valve unit V that is disposed in the fluid flow inversion cavity 27. In particular, the valve unit V is positioned opposite to the second port 22 via the first internal passage 26. The valve unit V thus positioned is composed of a valve element 24 and a valve seat 25 that are arranged and constructed so as to close and open the first internal passage 26 (the second port 22). Also, the first and third ports 21 and 23 communicate with each other via the second internal passage 28 and the fluid flow inversion cavity 27.

Further, as best shown in FIG. 6, the fluid flow inversion cavity 27 may preferably be formed in the valve body portion 20 so as to be positioned adjacent to (near) the magnetic actuator portion 10 (the connecting plate 13). In addition, the third port 23 may preferably be formed in the valve body portion 20 so as to be positioned closer to the magnetic actuator portion 10 than the first port 21. In particular, the third port 23 may preferably be positioned so as to be substantially directly opened into the fluid flow inversion cavity 27. Moreover, as best shown in FIG. 2, the second internal passage 28 may preferably be formed so as to have a cylindrical shape. Also, the second internal passage 28 may preferably be formed so as to extend along a valve axis BZ of the valve unit V.

As shown in FIG. 1, the magnetic actuator portion 10 includes a magnetic coil 11 that is electrically connected to a power source (not shown) via a connector 12. The magnetic coil 11 is arranged and constructed to move a valve stem 24a of the valve element 24 along the valve axis BZ of the valve unit V. As will be appreciated, when the magnetic coil 11 is actuated (FIGS. 1 and 3), the valve stem 24a is projected toward the valve seat 25, so that the valve element 24 can contact the valve seat 25 (i.e., the valve unit V is closed). As a result, the second port 22 (the first internal passage 26) is closed, so that only the first and third ports 21 and 23 can communicate with each other. Conversely, when the magnetic coil 11 is deactuated (FIGS. 4 and 6), the valve stem 24a is retracted into the magnetic coil 11, so that the valve element 24 can be moved away from the valve seat 25 (i.e., the valve unit V is opened). As a result, the second port 22 (the first internal passage 26) is opened, so that the first, second and third ports 21, 22 and 23 can communicate with each other. Further, the valve unit V may preferably be positioned such that the valve axis BZ thereof is substantially aligned with a center line of the first internal passage 26.

Further, as shown in FIGS. 1 and 6, the first internal passage 26 may preferably have a substantially rectilinear shape in order to avoid or reduce loss of pressure that is possibly produced therein. That is, the valve unit V and the second port 22 may preferably be linearly aligned with each other. As will be appreciated, when the loss of pressure is produced in the first internal passage 26, the liquid fuel introduced into the three-way valve 1 via the first port 21 cannot be precisely adjusted to the first setting pressure. As a result, the liquid fuel will be fed into the third external conduit 43A (the delivery tube 44A) at a pressure that is greater than the first setting pressure by the produced loss of pressure. That is, the liquid fuel cannot be fed into the third external conduit 43A (the delivery tube 44A) at the first setting pressure.

Next, operation of the fuel-feeding system S will be described in detail.

When the magnetic coil 11 of the magnetic actuator portion 10 is actuated based on a signal from the control unit, the valve unit V of the three-way valve 1 is closed as described above (FIGS. 1 and 3). As a result, the second port 22 (the first internal passage 26) is closed, so that only the first and third ports 21 and 23 can communicate with each other (i.e., the three-way valve 1 can be switched to the high pressure condition). In this condition, when the fuel pump 41 is actuated, the liquid fuel pumped by the fuel pump 41 flows through the first port 21, the second internal passage 28 and the fluid flow inversion cavity 27, and is fed into the third external conduit 43A (the delivery tube 44A) via the third port 23 without flowing through the second port 22. At this time, the second relief valve 43 may suitably function, so that the liquid fuel can be fed into the third external conduit 43A while it is maintained in the second setting pressure. Thus, the liquid fuel can be fed into the third external conduit 43A at the high pressure corresponding to the second setting pressure.

Conversely, when the magnetic coil 11 of the magnetic actuator portion 10 is deactuated based on the signal from the control unit, the valve unit V of the three-way valve 1 is opened as described above (FIGS. 4 and 6). As a result, the second port 22 (the first internal passage 26) is opened, so that the first to third ports 21, 22 and 23 can communicate with each other (i.e., the three-way valve 1 can be switched to the low pressure condition). In this condition, when the fuel pump 41 is actuated, the liquid fuel pumped by the fuel pump 41 flows through the first port 21, the second internal passage 28 and the fluid flow inversion cavity 27, and is fed into the third external conduit 43A (the delivery tube 44A) via the third port 23. At this time, the first relief valve 42 may suitably function because the second port 22 is opened, so that the liquid fuel can be fed into the third external conduit 43A while it is maintained in the first setting pressure. Thus, the liquid fuel can be fed into the third external conduit 43A at the low pressure corresponding to the first setting pressure.

According to the fuel-feeding system S thus constructed, the liquid fuel can be fed into the third external conduit 43A (the delivery tube 44A) at the first setting pressure or the second setting pressure by simply switching the three-way valve 1 between the first (low) pressure condition and the second (high) pressure condition. Also, the pressure of the liquid fuel fed into the third external conduit 43A can be accurately set to the first setting pressure or the second setting pressure by means of the first and second relief valves 42 and 43.

Further, in the fuel-feeding system S using the three-way valve 1, as shown by bold arrows in FIG. 6, the pumped liquid fuel introduced into the fluid flow inversion cavity 27 impinges against the connecting plate 13 and is then turned toward and introduced into the third port 23. Therefore, the liquid fuel may suitably function as a coolant, so as to effectively cool the magnetic actuator portion 10 (the magnetic coil 11). As a result, the magnetic coil 11 can be effectively prevented from increasing of impedance resulting from increase of temperature (i.e., prevented from reducing of driving current). Therefore, the magnetic coil 11 can be operated at reduced operating voltage.

Further, in order to increase cooling performance of the three-way valve 1, the connecting plate 13 may preferably be formed from a material having an excellent heat conductivity. Also, the connecting plate 13 can be treated so as to have an uneven surface, thereby increasing an area of contact with the liquid fuel. In such a case, the connecting plate 13 may preferably be treated so as to effectively prevent from producing turbulence in the fuel when the fuel pump 41 is actuated.

Further, in order to increase cooling performance of the three-way valve 1, the valve body portion 20 can be formed from a material having an excellent heat conductivity. In addition, cooling fins can be additionally formed in the valve body portion 20.

Naturally, various changes and modifications may be made to the three-way valve 1 of the fuel-feeding system S. For example, the arrangement of the first to third ports 21, 22 and 23 and the valve unit V can be changed, if necessary.

A representative example of the present invention has been described in detail with reference to the attached drawings. This detailed description is merely intended to teach a person of skill in the art further details for practicing preferred aspects of the present invention and is not intended to limit the scope of the invention. Only the claims define the scope of the claimed invention. Therefore, combinations of features and steps disclosed in the foregoing detailed description may not be necessary to practice the invention in the broadest sense, and are instead taught merely to particularly describe detailed representative examples of the invention. Moreover, the various features taught in this specification may be combined in ways that are not specifically enumerated in order to obtain additional useful embodiments of the present invention.

What is claimed is:

1. A fuel-feeding system, comprising:
a fuel tank containing liquid fuel;
a fuel pump capable of pumping the liquid fuel contained in the fuel tank;
a fuel injection valve capable of injecting the liquid fuel pumped by the fuel pump; and
a three-way valve having a first port, a second port and a third port;
wherein the three-way valve is constructed so as to be switched between a first condition in which the first, second and third ports communicate with each other and a second condition in which only the first and third ports communicate with each other,
wherein the first port communicates with the fuel pump via a first external conduit,
wherein the second port communicates with the fuel tank via a second external conduit having a first relief valve that is set to a first setting pressure,
wherein the third port is communicated with the fuel tank via a third external conduit having a second relief valve that is set to a second setting pressure higher than the first setting pressure, and
wherein the fuel injection valve is connected to the third external conduit at a position between the third port and the second relief valve, so that a pressure of the liquid fuel fed to the fuel injection valve can be switched between the first setting pressure and the second setting pressure when the three-way valve is switched between the first condition and the second condition.

2. The fuel-feeding system as defined in claim 1, wherein the three-way valve comprises a valve unit that is arranged and constructed to close and open the second port, and wherein the valve unit is positioned opposite to the second port via a first internal passage that is substantially linearly configured.

3. The fuel-feeding system as defined in claim 2, wherein the three-way valve comprises a solenoid valve having a magnetic coil, wherein the first and third ports communicate with each other via a second internal passage that extends along a valve axis of the valve unit and a fluid roundabout cavity that is positioned near the magnetic coil, wherein the third port is positioned closer to the magnetic coil than the first port, wherein the valve unit is disposed in the fluid roundabout cavity, and wherein the first and third ports, the second internal passage and the fluid roundabout cavity are arranged and constructed such that the liquid fuel introduced into the second internal passage via the first port can be introduced into the fluid roundabout cavity and then be directed into the third port.

4. A three-way valve, comprising:
a magnetic coil;
a valve unit that is actuated by the magnetic coil;
a first port, a second port and a third port;
a fluid roundabout cavity in which the valve unit is disposed; and
a main internal passage that extends along a valve axis of the valve unit,
wherein the three-way valve is constructed so as to be switched between a first condition in which the first, second and third ports communicate with each other and a second condition in which only the first and third ports communicate with each other,
wherein in the first condition, fluid introduced via the first port can flow through the second and third ports, and in the second condition, the fluid introduced via the first port can flow through only the third port without flowing through the second port,
wherein the third port is positioned closer to the magnetic coil than the first port, and
wherein the first and third ports, the main internal passage and the fluid roundabout cavity are arranged and constructed such that the fluid introduced into the main internal passage via the first port can be introduced into the fluid roundabout cavity and then be directed into the third port.
